(19) United States
(12) Patent Application Publication
(10) Pub. No.: US 2026/0023281 A1
(43) Pub. Date: Jan. 22, 2026

(54) DISPLAY DEVICE

(71) Applicant: Japan Display Inc., Tokyo (JP)

(72) Inventor: Junko NAGASAWA, Tokyo (JP)

(21) Appl. No.: 19/273,642

(22) Filed: Jul. 18, 2025

(30) Foreign Application Priority Data
Jul. 22, 2024 (JP) 2024-116886

(51) Int. Cl. G02F 1/1335; G02F 1/1334

(52) U.S. Cl. CPC G02F 1/133504; G02F 1/1334; G02F 1/133524

(57) ABSTRACT

According to one embodiment, a display device includes a light guide, a first transparent substrate, a second transparent substrate, a liquid crystal layer, a first transparent layer, and a protective layer. The first transparent layer has a refractive index smaller than refractive indices of the second transparent substrate and the protective layer. The protective layer has light scattering properties higher than those of the second transparent substrate.

### CROSS-REFERENCE TO RELATED APPLICATIONS

This application is based upon and claims the benefit of priority from Japanese Patent Application No. 2024-116886, filed Jul. 22, 2024, the entire contents of which are incorporated herein by reference.

### FIELD

Embodiments described herein relate generally to a display device.

### BACKGROUND

Various types of display devices using polymer dispersed liquid crystals in which a scattered state for scattering incident light and a transparent state for transmitting incident light can be switched have been suggested. In display devices using polymer dispersed liquid crystals, an edge light method in which a light emitting module is provided in an end portion of a display panel is used in some cases. Since such display devices have a high transmittance, the use of the display devices in various fields is expected. In contrast, in such display devices, there is a demand for improving a phenomenon that brightness decreases as the distance from the light emitting module increases.

### BRIEF DESCRIPTION OF THE DRAWINGS

FIG. 1 is a plan view showing a configuration example of a display device of a present embodiment.

FIG. 2 is a cross-sectional view showing a configuration example of the display panel shown in FIG. 1.

FIG. 3 is an exploded perspective view showing main portions of the display device shown in FIG. 1.

FIG. 4 is a plan view showing a configuration example of a second substrate shown in FIG. 2.

FIG. 5 is a cross-sectional view showing a configuration example of the display device of the present embodiment.

FIG. 6 is a cross-sectional view showing another configuration example of the second substrate shown in FIG. 2.

FIG. 7 is a plan view showing a configuration example of the second substrate shown in FIG. 6.

### DETAILED DESCRIPTION

In general, according to one embodiment, there is provided a display device including a light guide, a first transparent substrate, a second transparent substrate provided between the light guide and the first transparent substrate, a liquid crystal layer provided between the first transparent substrate and the second transparent substrate and containing streaky polymer and liquid crystal molecules, a first transparent layer provided between the light guide and the first transparent substrate and including an aperture facing the liquid crystal layer, and a protective layer provided between the light guide and the first transparent substrate, and overlapping with the aperture in plan view. The first transparent layer has a refractive index smaller than refractive indices of the second transparent substrate and the protective layer. The protective layer has light scattering properties higher than those of the second transparent substrate.

According to such a configuration, a display device capable of suppressing the degradation in display quality can be provided.

Embodiments will be described hereinafter with reference to the accompanying drawings. The disclosure is merely an example, and proper changes in keeping with the spirit of the invention, which are easily conceivable by a person of ordinary skill in the art, come within the scope of the invention as a matter of course. In addition, in some cases, in order to make the description clearer, the widths, thicknesses, shapes, etc., of the respective portions are illustrated schematically in the drawings, rather than as an accurate representation of what is implemented. However, such schematic illustration is merely exemplary, and in no way restricts the interpretation of the invention. In addition, in the specification and drawings, the same elements as those described in connection with preceding drawings are denoted by like reference numbers, and detailed description thereof is omitted unless necessary.

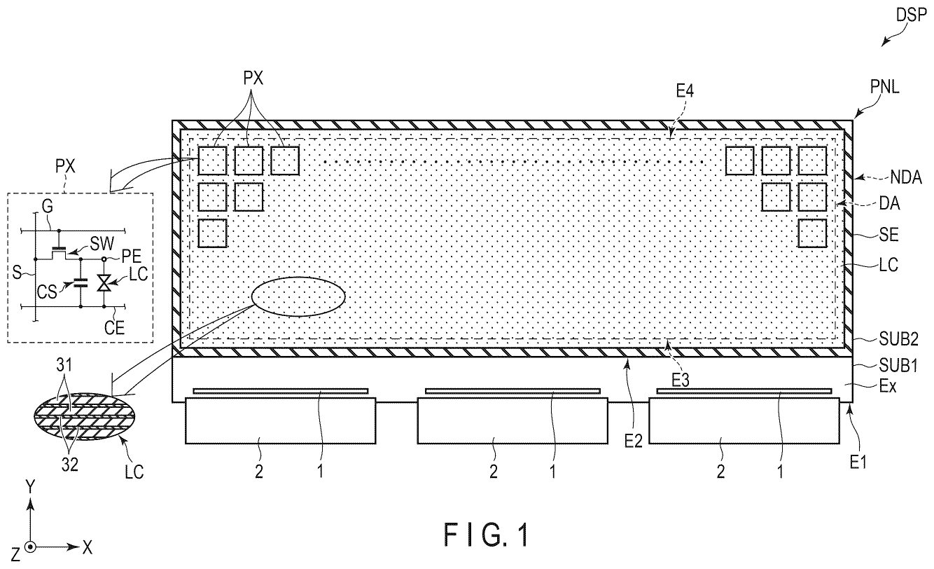

FIG. 1 is a plan view showing a configuration example of a display device DSP of a present embodiment. In one example, the first direction X, the second direction Y and the third direction Z are orthogonal to each other, but may intersect at an angle other than ninety degrees. The first direction X and the second direction Y correspond to the directions parallel to the surface of a substrate which constitutes the display device DSP, and the third direction Z corresponds to the thickness direction of the display device DSP. As described herein, a direction from the first substrate SUB1 toward the second substrate SUB2 is referred to as an upper side (or merely above), and a direction from the second substrate SUB2 toward the first substrate SUB1 is referred to as a lower side (or merely below). According to “a second member above/on a first member” and “a second member below/under a first member”, the second member may be in contact with the first member or may be separated from the first member. It is assumed that an observation position for observing the display device DSP is on the tip side of the arrow indicating the third direction Z. When the X-Y plane defined by the first direction X and the second direction Y is viewed at the observation position, the appearance is referred to as a plan view.

In the present embodiment, a liquid crystal display device employing polymer dispersed liquid crystal will be described as an example of the display device DSP. The display device DSP comprises a display panel PNL, an IC chip 1, and a wiring board 2.

The display panel PNL comprises a first substrate SUB1, a second substrate SUB2, a liquid crystal layer LC, and a seal SE. The first substrate SUB1 and the second substrate SUB2 are formed in a flat plate shape parallel to the X-Y plane. The first substrate SUB1 and the second substrate SUB2 overlap with each other in plan view. The first substrate SUB1 and the second substrate SUB2 are bonded to each other by the seal SE.

The first substrate SUB1 has an edge portion E1 extending along the first direction X. The second substrate SUB2 has an edge portion E2 extending along the first direction X. The edge portion E2 does not overlap with the edge portion E1 in plan view. The first substrate SUB1 has an extending portion EX which extends from the edge portion E2 in the second direction Y. In the example illustrated, the extending portion Ex corresponds to an area of the first substrate SUB1, which does not overlap with the second substrate SUB2.

The liquid crystal layer LC is held between the first substrate SUB1 and the second substrate SUB2, and is sealed by the seal SE. In FIG. 1, the liquid crystal layer LC is represented by dots and the seal SE is represented by hatch lines.

As schematically shown in an enlarged view in FIG. 1, the liquid crystal layer LC comprises polymer dispersed liquid crystals containing polymers 31 and liquid crystal molecules 32. In one example, the polymers 31 are liquid crystalline polymers. The polymers 31 are formed in a streaky shape extending along the first direction X. The liquid crystal molecules 32 are dispersed in the gaps of the polymers 31, and are aligned such that their long axes are parallel to the first direction X. Each of the polymers 31 and the liquid crystal molecules 32 has optical anisotropy or refractive anisotropy. The responsiveness of the polymers 31 to an electric field is lower than that of the liquid crystal molecules 32 to an electric field.

In one example, the alignment direction of the polymers 31 is hardly varied regardless of the presence or absence of the electric field. In contrast, the alignment direction of the liquid crystal molecules 32 is varied in accordance with the electric field, in a state in which a voltage higher than or equal to the threshold value is applied to the liquid crystal layer LC. In a state in which the voltage is not applied to the liquid crystal layer LC, optical axes of the polymers 31 and the liquid crystal molecules 32 are parallel to one another and the light made incident on the liquid crystal layer LC is not substantially scattered in the liquid crystal layer LC and transmitted (transparent state). In a state in which the voltage is applied to the liquid crystal layer LC, the optical axes of the polymers 31 and the liquid crystal molecules 32 intersect one another and the light made incident on the liquid crystal layer LC is scattered in the liquid crystal layer LC (scattered state).

The display panel PNL comprises a display portion DA which displays images, and a frame-shaped non-display portion NDA surrounding the display portion DA, in the area where the first substrate SUB1 and the second substrate SUB2 overlap, in plan view. The seal SE is located at the non-display portion NDA. The display portion DA comprises pixels PX arrayed in matrix in a first direction X and a second direction Y. The display portion DA has edge portions E3 and E4 extending in the first direction X. The edge portion E3 is located between the edge portions E2 and E4 in the second direction Y.

As shown in an enlarged view of FIG. 1, each of the pixels PX comprises a switching element SW, a pixel electrode PE, a common electrode CE, a liquid crystal layer LC, and the like. The switching element SW is formed of, for example, a thin-film transistor (TFT) and is electrically connected to the scanning line G and the signal line S. The scanning line G extends in the first direction X, and is electrically connected to the switching element SW in each of pixels PX arranged in the first direction X. The signal line S extends in the second direction Y, and is electrically connected to the switching element SW of each of the pixels PX arranged in the second direction Y. The pixel electrode PE is electrically connected to the switching element SW. Each pixel electrode PE faces the common electrode CE, and drives the liquid crystal layer LC (in particular, liquid crystal molecules 32) by the electric field generated between the pixel electrode PE and the common electrode CE. For example, capacitance CS is formed between an electrode having the same potential as the common electrode CE and an electrode having the same potential as the pixel electrode PE.

The IC chip 1 and the wiring board 2 are each connected to the extending portion Ex. The IC chip 1 incorporates, for example, a display driver which outputs a signal necessary for image display, and the like. The wiring board 2 is a flexible printed circuit which can be bent. Incidentally, the IC chip 1 may be connected to the wiring board 2. The IC chip 1 and the wiring board 2 may read signals from the display panel PNL. However, they mainly function as signal sources which supply signals to the display panel PNL.

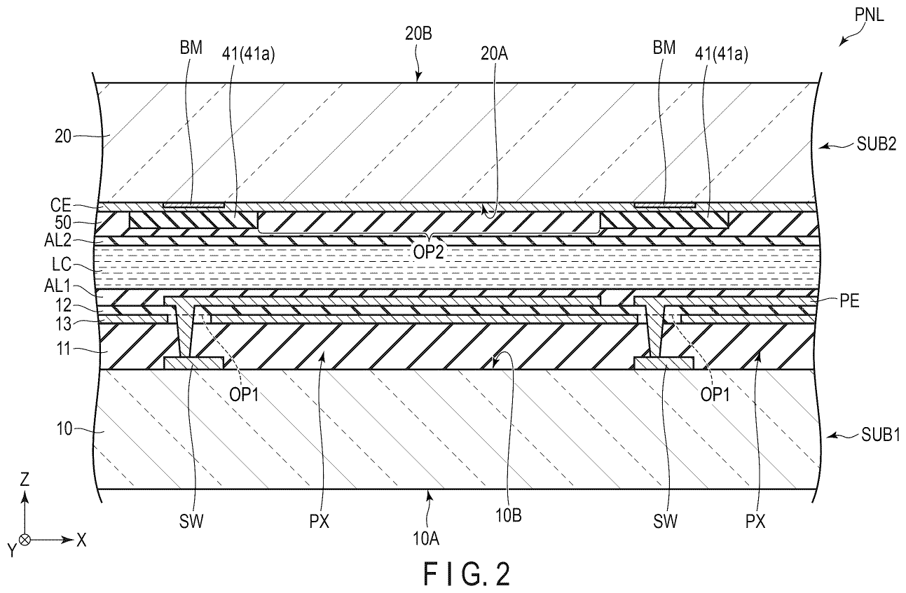

FIG. 2 is a cross-sectional view showing a configuration example of the display panel PNL shown in FIG. 1. The cross-section of the display portion DA in the X-Z plane defined by the first direction X and the third direction Z will be described here.

The first substrate SUB1 comprises a transparent substrate 10, insulating layers 11 and 12, a capacitive electrode 13, the switching elements SW, the pixel electrodes PE, and an alignment film AL1. The first substrate SUB1 further comprises the scanning lines G and the signal lines S shown in FIG. 1. The scanning lines G are provided, for example, between the transparent substrate 10 and the insulating layer 11.

The transparent substrate 10 has a main surface (lower surface) 10A and a main surface (upper surface) 10B on a side opposite to the main surface 10A. The main surfaces 10A and 10B are the surfaces substantially parallel to the X-Y plane. The switching elements SW are provided on, for example, the main surface 10B. The insulating layer 11 covers the switching elements SW and the main surface 10B. The capacitive electrode 13 is provided between the insulating layer 11 and the insulating layer 12.

The pixel electrodes PE are provided between the insulating layer 12 and the alignment film AL1, for the respective pixels PX. The pixel electrodes PE are electrically connected to the switching elements SW through apertures OP1 of the capacitive electrode 13. The pixel electrodes PE overlap with the capacitive electrode 13 with the insulating layer 12 sandwiched therebetween, to form the capacitances CS of the pixels PX. The alignment film AL1 covers the pixel electrodes PE and the insulating layer 12.

The second substrate SUB2 comprises a transparent substrate 20, a light shielding layer BM, the common electrode CE, a transparent layer 41, a protective layer 50, and an alignment film AL2. The transparent substrate 20 has a main surface (lower surface) 20A and a main surface (upper surface) 20B on a side opposite to the main surface 20A. The main surfaces 20A and 20B are the surfaces substantially parallel to the X-Y plane. The main surface 20A of the transparent substrate 20 faces the main surface 10B of the transparent substrate 10.

The light shielding layer BM is provided between the main surface 20A and the alignment film AL2. In the example shown in FIG. 2, the light shielding layer BM is formed on the main surface 20A. The light shielding layer BM is located above the switching elements SW and above the signal lines S and scanning lines G (not shown).

The common electrode CE is provided between the main surface 20A and the alignment film AL2. In the example shown in FIG. 2, the common electrode CE is provided on the main surface 20A. The common electrode CE covers the light shielding layer BM. The common electrode CE is arranged across a plurality of pixels PX and faces each of the pixel electrodes PE through the liquid crystal layer LC in the third direction Z. The common electrode CE is electrically connected to the capacitive electrode 13 and has the same electric potential as the capacitive electrode 13.

The transparent layer 41 is provided between the main surface 20A and the alignment film AL2. In the example shown in FIG. 2, the transparent layer 41 is provided between the common electrode CE and the protective layer 50, and is formed on the surface of the common electrode CE, which faces the liquid crystal layer LC. The transparent layer 41 is in contact with the common electrode CE and the protective layer 50. The transparent layer 41 overlaps with the display portion DA in plan view.

In the example shown in FIG. 2, the transparent layer 41 includes a plurality of band portions 41a. The plurality of band portions 41a are arranged in the first direction X, extend along the second direction Y, and are substantially shaped in an isosceles triangle. For example, the band portions 41a are located above the switching elements SW in the third direction Z and overlap with the switching elements SW in planar view. In addition, the band portions 41a are located above the light shielding layer BM and overlap with the light shielding layer BM in planar view. Although not shown, the band portions 41a may be located above the signal lines S in the third direction Z and may overlap with the signal lines S in planar view. The shape of the band portions 41a will be described later.

The transparent layer 41 has an aperture OP2 between the adjacent band portions 41a. The aperture OP2 faces the liquid crystal layer LC. In the example shown in FIG. 2, the common electrode CE is exposed from the transparent layer 41 through the aperture OP2.

The protective layer 50 covers the transparent layer 41. The protective layer 50 is provided between the transparent layer 41 and the alignment film AL2. In addition, the protective layer 50 is provided between the main surface 20A and the alignment film AL2, in the aperture OP2. In the example shown in FIG. 2, the protective layer 50 is provided between the common electrode CE and the alignment film AL2. The protective layer 50 overlaps with the aperture OP2 in plan view. In the example shown in FIG. 2, the protective layer 50 is in contact with the transparent layer 41 and the alignment film AL2, and is in contact with the transparent layer 41, the alignment film AL2, and the common electrode CE, in the aperture OP2. The alignment film AL2 covers the protective layer 50. The liquid crystal layer LC is located between the first substrate SUB1 and the second substrate SUB2 and is in contact with the alignment films AL1 and AL2.

In the first substrate SUB1, the switching element SW, the insulating layers 11 and 12, the capacitive electrode 13, the pixel electrode PE, and the alignment film AL1 are located between the main surface 10B and the liquid crystal layer LC. In the second substrate SUB2, the light shielding layer BM, the common electrode CE, the transparent layer 41, the protective layer 50, and the alignment film AL2 are located between the main surface 20A and the liquid crystal layer LC.

The transparent substrates 10 and 20 are insulating substrates such as glass substrates or plastic substrates. The insulating layers 11 and 12 are inorganic insulating layers of silicon oxide, silicon nitride, silicon oxynitride or the like, or organic insulating layers of acrylic resin or the like.

The capacitive electrode 13, the pixel electrodes PE, and the common electrode CE are transparent electrodes formed of a transparent conductive material such as indium tin oxide (ITO) or indium zinc oxide (IZO). The light shielding layer BM may be a light absorbing layer formed of a light absorbing material or a light reflective layer formed of a light reflective material. In addition, the light shielding layer BM may be an insulating layer formed of an inorganic material or an organic material or may be a conductive layer formed of a metallic material.

The transparent layer 41 is, for example, an insulating layer formed of an organic material such as siloxane-based resin or fluorine-based resin. The protective layer 50 is a layer formed of a material having light scattering properties. The protective layer 50 is formed of, for example, an insulating material containing a light scattering filler. The filler is, for example, an inorganic filler or a hollow filler. The filler is, for example, hollow silica. The insulating material is, for example, an inorganic insulating material or an organic insulating material.

The alignment films AL1 and AL2 are horizontal alignment films having an alignment restriction force substantially parallel to the X-Y plane. In one example, the alignment films AL1 and AL2 are subjected to an alignment treatment along the first direction X. Incidentally, the alignment treatment may be a rubbing treatment or an optical alignment treatment.

The transparent substrate 10 has a thickness T1, and the transparent substrate 20 has a thickness T2. In the illustrated example, the thickness T1 is equal to the thickness T2. The transparent layer 41 has a thickness T41. The thickness T41 is, for example, 1 μm or more.

The transparent substrate 10 has a refractive index n10, the transparent substrate 20 has a refractive index n20, and the protective layer 50 has a refractive index n50. The transparent layer 41 has a refractive index n41 that is smaller than the refractive indices n10, n20, and n50. For example, the refractive indices n10 and n20 are approximately 1.4 to 2.5, the refractive index n50 is approximately 1.5, and the refractive index n41 is 1.0 or more and 1.41 or less.

The protective layer 50 has higher light scattering properties than those of the transparent substrate 20. For example, the light scattering properties of the protective layer 50 are equivalent to those of the transparent layer 41.

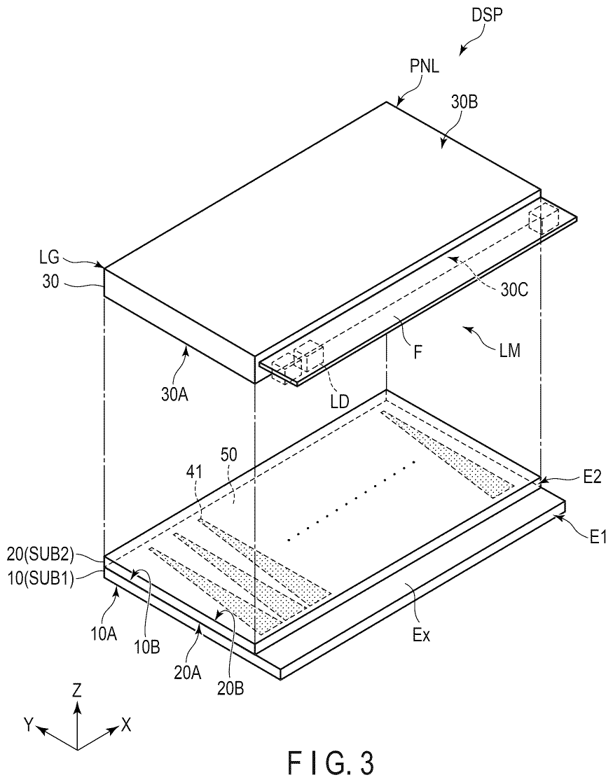

FIG. 3 is an exploded perspective view showing main portions of the display device DSP shown in FIG. 1. In FIG. 3, the transparent layer 41 is represented by dotted lines as if it were transparent.

The display device DSP comprises a light guide element LG and a light emitting module LM in addition to the display panel PNL. The first substrate SUB1, the second substrate SUB2, and the light guide element LG are arranged in this order along the third direction Z.

The light emitting module LM comprises a plurality of light emitting elements LD and a wiring board F. The plurality of light emitting elements LD are arranged at intervals in the first direction X. Each of the plurality of light emitting elements LD is connected to the wiring board F. In the example shown in FIG. 3, each of the plurality of light emitting elements LD overlaps with the extending portion Ex in plan view. The light emitting elements LD are, for example, light emitting diodes. The light emitting elements LD include red light emitting portions, green light emitting portions, and blue light emitting portions, which will not be described in detail. The light emitted from the light emitting elements LD travels along a direction of an arrow, which represents the second direction Y.

The light guide element LG comprises a transparent substrate 30. The transparent substrate 30 has a main surface (lower surface) 30A and a main surface (upper surface) 30B on a side opposite to the main surface 30A. The main surfaces 30A and 30B are the surfaces substantially parallel to the X-Y plane. The main surface 30A faces the main surface 20B of the transparent substrate 20.

The transparent substrate 30 has a side surface 30C. The side surface 30C is the surface substantially parallel to an X-Z plane defined by the first direction X and the third direction Z. The side surface 30C is located on the side facing the light emitting elements LD in plan view. The side surface 30C faces the light emitting elements LD in the second direction Y.

The transparent substrate 30 is bonded to the transparent substrate 20. In the example shown in FIG. 3, the side surface 30C is located above the edge portion E2 of the transparent substrate 20, but may be located above the extending portion Ex or further outward from the edge portion E1.

The transparent substrate 30 is, for example, an insulating substrate. The transparent substrate 30 is, for example, a glass substrate but may be a plastic substrate formed of polymethyl methacrylate (PMMA) or polycarbonate (PC). In one example, the transparent substrate 30 is a single substrate.

The transparent substrate 30 has a thickness T3. In one example, the thickness T3 is thicker than the thickness T1 of the transparent substrate 10 and the thickness T2 of the transparent substrate 20. Incidentally, the thickness T3 may be equal to thickness T1 and the thickness T2. In one example, the thickness T3 is 200 μm to 2,000 μm.

The transparent substrate 30 has a refractive index n30. The refractive index n30 is equivalent to the refractive indices n10 and n20 of the transparent substrates 10 and 20, respectively, and is higher than the refractive index n41 of the transparent layer 41. In this example, “equivalent” is not limited to a case where the difference in refractive index is zero, but indicates a case where the difference in refractive index is 0.03 or less.

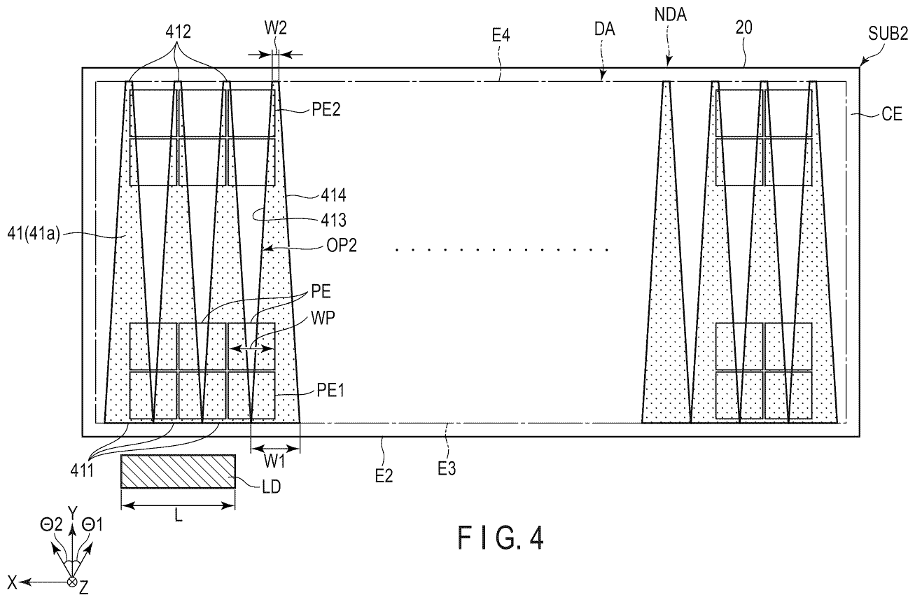

FIG. 4 is a plan view showing a configuration example of the second substrate shown in FIG. 2. In FIG. 4, the protective layer 50 is omitted. In addition, in FIG. 4, the band portion 41a is shown schematically with the width enlarged in the first direction X. Furthermore, in FIG. 4, the area overlapping with the display portion DA is represented by a dashed line.

In the example shown in FIG. 4, the transparent layer 41 includes a plurality of band portions 41a arranged in the first direction X. Each of the band portions 41a has a first end portion 411 on the side facing the light emitting element LD, a second end portion 412 on the side opposite to the first end portion 411, a first edge 413, and a second edge 414. The first end portion 411 is provided along the same straight line along the first direction X.

In the example shown in FIG. 4, the first end portion 411 overlaps with the edge portion E3 of the display portion DA in plan view, and the second end portion 412 overlaps with the edge portion E4 of the display portion DA in plan view. However, the end portions are not limited to this example. From the viewpoint of suppressing light leakage between the edge portion E2 of the second substrate and the display portion DA, the first end portion 411 is desirably close to the edge portion E2 beyond the display portion DA.

Each of the first end portion 411 and the second end portion 412 has a first width W1 and a second width W2. Incidentally, as described herein, the width corresponds to the length along the first direction X. The first width W1 is larger than the second width W2. In one example, the first width W1 is smaller than the width L of a single light emitting element LD, and the single light emitting element LD is provided across the plurality of band portions 41a arranged in the first direction X. Furthermore, the first width W1 is equal to or less than the width WP of the single pixel electrode PE (or the pitch of the pixel electrodes PE arranged in the first direction X). For all the band portions 41a, the first width W1 and the second width W2 are substantially the same.

The first edge 413 and the second edge 414 extend in a direction different from the first direction X and the second direction Y, at positions between the first end portion 411 and the second end portion 412. For example, a direction intersecting the second direction Y clockwise at an acute angle is defined as direction D1, and a direction intersecting the second direction Y counterclockwise at an acute angle is defined as direction D2. In the example shown in FIG. 4, an angle θ1 formed between the second direction Y and the direction D1 is the same as the angle θ2 formed between the second direction Y and the direction D2, but the angles are not limited to this example. The angle formed between the second direction Y and the direction D1 may be different from the angle formed between the second direction Y and the direction D2.

The first edge 413 extends along the direction D1, and the second edge 414 extends along the direction D2. In this example, each of the first edge 413 and the second edge 414 extends linearly, but may be formed in a curved shape. The first width W1 and the second width W2 correspond to intervals between the first edge 413 and the second edge 414 along the first direction X.

The band portion 41a having this shape has a width gradually decreasing at a constant rate or any rate, from the first end portion 411 toward the second end portion 412. The pitch between the adjacent band portions 41a is desirably two times or less than the width WP of the pixel electrode PE (or the pitch of the pixel electrodes PE arranged in the first direction X).

The common electrode CE is exposed between the adjacent band portions 41a, i.e., through the aperture OP2. Although not shown, the protective layer 50 overlaps with the band portions 41a and the apertures OP2. The pixel electrode PE overlaps with two adjacent band portions 41a in plan view.

In the display portion DA, the pixel electrode PE1 closest to the light emitting element LD and the pixel electrode PE2 farthest from the light emitting element LD will be focused. The area where the pixel electrode PE1 overlaps with the transparent layer 41 is larger than the area where the pixel electrode PE2 overlaps with the transparent layer 41. In other words, the area where the main surface 20A overlaps with the pixel electrode PE1 without the transparent layer 41 interposed therebetween is smaller than the area where the main surface 20A overlaps with the pixel electrode PE2 without the transparent layer 41 interposed therebetween. Thus, in the area close to the light emitting element LD, the area where the pixel electrode PE overlaps with the transparent layer 41 is larger than that in the area separated from the light emitting element LD.

The shape of the transparent layer 41 is not limited to the shape described above. The shape of the transparent layer 41 may be such that, for example, the area where the pixel electrode PE overlaps with the transparent layer 41 in the area close to the light emitting element LD is larger than that in the area separated from the light emitting element LD.

As will be described later, the area overlapping with the transparent layer 41 corresponds to the area where light from the light emitting element LD is not substantially made incident on the display panel PNL, and the area overlapping with the main surface 20A without the transparent layer 41 interposed therebetween corresponds to the area where light from the light emitting element LD can be made incident on the display panel PNL.

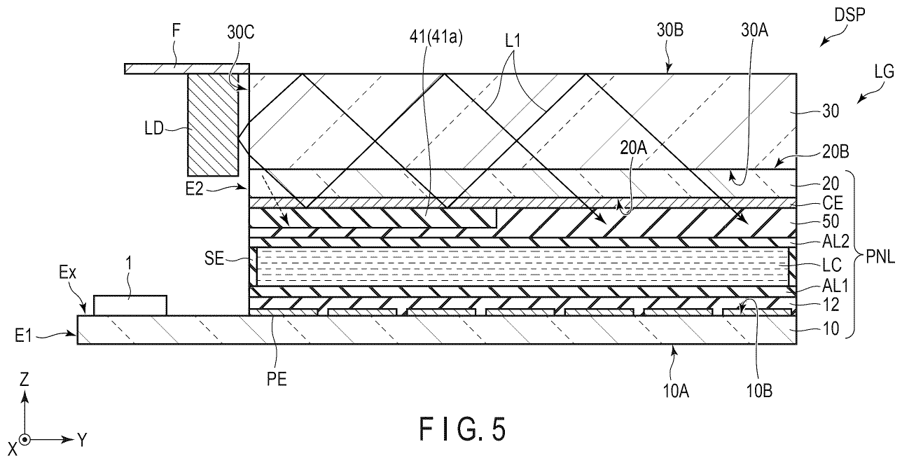

FIG. 5 is a cross-sectional view showing a configuration example of the display device DSP of the present embodiment. As regards the display panel PNL, only main portions are shown in the figure. The light emitted from the light emitting element LD will be described with reference to FIG. 5.

The light emitting element LD emits light L1 toward the side surface 30C of the transparent substrate 30. Since an air layer exists between the light emitting element LD and the side surface 30C, the light L1 emitted from the light emitting element LD is refracted on the side surface 30C and made incident on the transparent substrates 20 and 30. The light traveling toward the main surface 30B, of the light L1 made incident on the transparent substrate 30, is reflected on an interface between the transparent substrate 30 and the air layer. In addition, part of the light traveling toward the transparent layer 41, of the light L1 made incident on the transparent substrate 20, is reflected on the interface between the common electrode CE and the transparent layer 41 and does not reach the alignment film AL2, the liquid crystal layer LC, and the first substrate SUB1. In contrast, light having an incident angle smaller than the critical angle, among the light traveling from the transparent substrate 20 toward the transparent layer 41, passes through the transparent layer 41, as represented by the dashed line, and reaches the alignment film AL2, the liquid crystal layer LC, and the first substrate SUB1.

Thus, most of the light L1 travels inside the transparent substrates 20 and 30 while being repeatedly reflected, in the vicinity of the side surface 30C (or the area where the transparent layer 41 is provided). The light traveling toward the area where the transparent layer 41 does not exist, among the traveling light L1, passes through the protective layer 50 and is made incident on the liquid crystal layer LC and the first substrate SUB1.

In the liquid crystal layer LC of pixels to which a voltage is applied, the light L1 is scattered. In addition, the light L1 passes through the liquid crystal layer LC of pixels to which no voltage is applied. The display device DSP can be observed from the main surface 10A side and can also be observed from the main surface 30B side. In addition, even when the display device DSP is observed from the main surface 10A side or observed from the main surface 30B side, a background of the display device DSP can be observed via the display device DSP.

According to the present embodiment, degradation in the display quality of the display panel PNL can be suppressed.

When the brightness distribution of the light L1 from the light emitting element LD is focused, brightness tends to decrease in areas separated from the light emitting element LD. One of reasons for the decrease in brightness is unwanted absorption of the light L1 by the liquid crystal layer LC, the switching element SW, the signal lines S, various insulating layers, and the like.

The area where the transparent layer 41 overlaps with the pixel electrode PE corresponds to the area where the light from the light emitting element LD is hardly made incident on the alignment film AL1 and the liquid crystal layer LC. The area where the transparent layer 41 does not overlap with the pixel electrode PE (or the area between adjacent transparent layers 41) corresponds to the area where the light from the light emitting element LD is made incident on the liquid crystal layer LC through the protective layer 50.

In the area close to the light emitting element LD, the area of overlapping of the transparent layer 41 per pixel electrode PE is larger compared to the area separated from the light emitting element LD. Therefore, in the area close to the light emitting element LD, the incidence of the light L1 on the display panel PNL is suppressed, and the absorption of the light L1 by the liquid crystal layer LC, the switching elements SW, the signal lines S, various insulating layers, and the like, is also suppressed. In contrast, the incidence of the light L1 on the display panel PNL is promoted in the area separated from the light emitting element LD. As described above, the light from the light emitting element LD attenuates as the light travels away from the light emitting element LD. The area where the pixel electrode PE1 and the transparent layer 41 overlap as shown in FIG. 4, is larger than the area where the pixel electrode PE2 and the transparent layer 41 overlap. For this reason, the area where the light L1 can be made incident on the pixel electrode PE1 is smaller than the area where the light L1 can be made incident on the pixel electrode PE2. In contrast, the intensity of light incident on the pixel electrode PE1 is stronger than the intensity of light incident on pixel electrode PE2. Therefore, the brightness of the display panel PNL at the pixel electrodes PEL and PE2 can be equalized.

In such a display device DSP, undesirable light scattering may occur in the transparent layer 41. As a result, a boundary between the area overlapping with the transparent layer 41 and the area not overlapping with the transparent layer 41 can easily be visually recognized, in plan view, which may cause the display quality of the display panel PNL to be degraded.

The transparent layer 41 includes the aperture OP2. The aperture OP2 corresponds to an area where the transparent layer 41 is not provided. The protective layer 50 is provided so as to overlap with the aperture OP2. The protective layer 50 has light scattering properties. As a result, occurrence of differences in light scattering properties between the area overlapping with the transparent layer 41 and the area overlapping with the aperture OP2 (i.e., the area not overlapping with the transparent layer 41) can be suppressed. Accordingly, the situation that the boundary between the area overlapping with the transparent layer 41 and the area not overlapping with the transparent layer 41 can easily be visually recognized, on the display panel PNL, can be suppressed.

Thus, according to the present embodiment, the degradation in display quality of the image displayed on the display panel PNL can be suppressed.

Next, the other configuration examples of the present embodiment will be described.

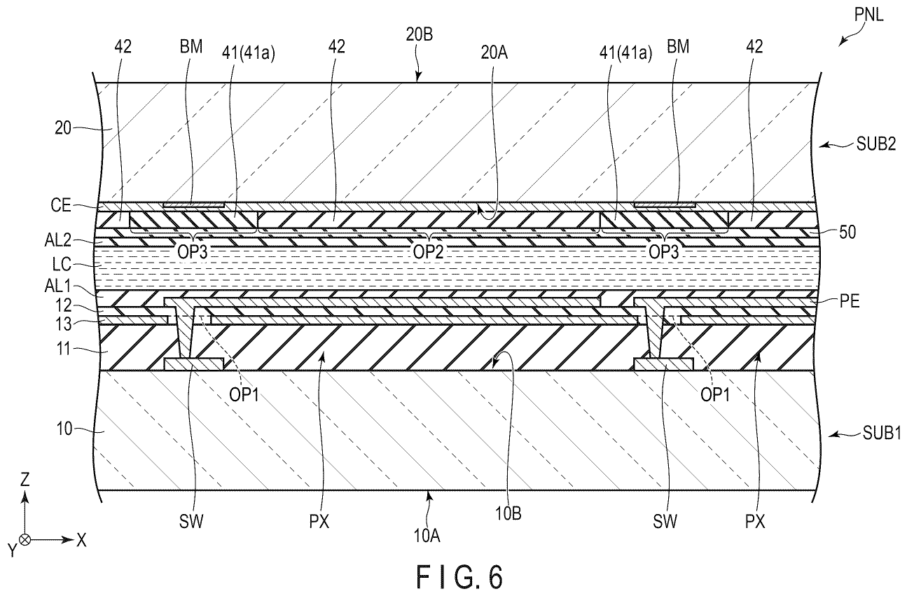

FIG. 6 is a cross-sectional view showing another configuration example of the second substrate SUB2 shown in FIG. 2. Description of the same configuration as the above-described configuration example will be omitted with reference to the above description. The configuration example shown in FIG. 6 is different from that shown in FIG. 2 in that the second substrate SUB2 further comprises a transparent layer 42.

The transparent layer 41 is formed on the surface facing the liquid crystal layer LC of the common electrode CE. The transparent layer 41 is in contact with the common electrode CE, the protective layer 50, and the transparent layer 42. The transparent layer 41 includes a plurality of band portions 41a arranged in the first direction X. The transparent layer 41 has the aperture OP2 facing the liquid crystal layer LC, at a position between adjacent band portions 41a.

The transparent layer 42 is provided between the transparent substrate 20 and the protective layer 50. In the example shown in FIG. 6, the transparent layer 42 is provided between the common electrode CE and the protective layer 50 and is formed on the surface facing the liquid crystal layer LC of the common electrode CE. Although not shown, the transparent layer 42 may be formed on the main surface 20A.

The transparent layer 42 is provided in the aperture OP2 in plan view. From another viewpoint, the transparent layer 42 includes a plurality of apertures OP3 facing the liquid crystal layer LC, and the band portion 41a is provided in each of the plurality of apertures OP3. The plurality of apertures OP3 are arranged in the first direction X and extend in the second direction Y. The apertures OP3 have the same planar shape as the band portion 41a.

The transparent layer 42 is in contact with the common electrode CE, the transparent layer 41, and the protective layer 50. The transparent layer 41 and the transparent layer 42 are arranged alternately in the first direction X.

The protective layer 50 is provided between the transparent layer 41 and the alignment film AL2, and between the transparent layer 42 and the alignment film AL2. The protective layer 50 covers the transparent layer 41 and the transparent layer 42. In the example shown in FIG. 6, the protective layer 50 is in contact with the transparent layer 41, the transparent layer 42, and the alignment film AL2. The protective layer 50 overlaps with the aperture OP2 in plan view.

The transparent layer 42 is formed of a material different from the material of the protective layer 50. The transparent layer 42 is, for example, an insulating layer formed of an organic material such as acrylic resin, an inorganic material such as silicon dioxide, or glass. When the transparent layer 42 is formed on the main surface 20A, the transparent layer 42 and the transparent substrate 20 may be integrally formed of the same material.

The transparent layer 42 has a thickness T42. The thickness T42 is, for example, 1 μm or more. In the example shown in FIG. 6, the thickness T42 is equivalent to the thickness T41 of the transparent layer 41.

The transparent layer 42 has a refractive index n42. The refractive index n42 is equivalent to the refractive index n50 of the protective layer 50 and higher than the refractive index n41 of the transparent layer 41. In this example, “equivalent” is not limited to a case where the difference in refractive index is zero, but indicates a case where the difference in refractive index is 0.03 or less.

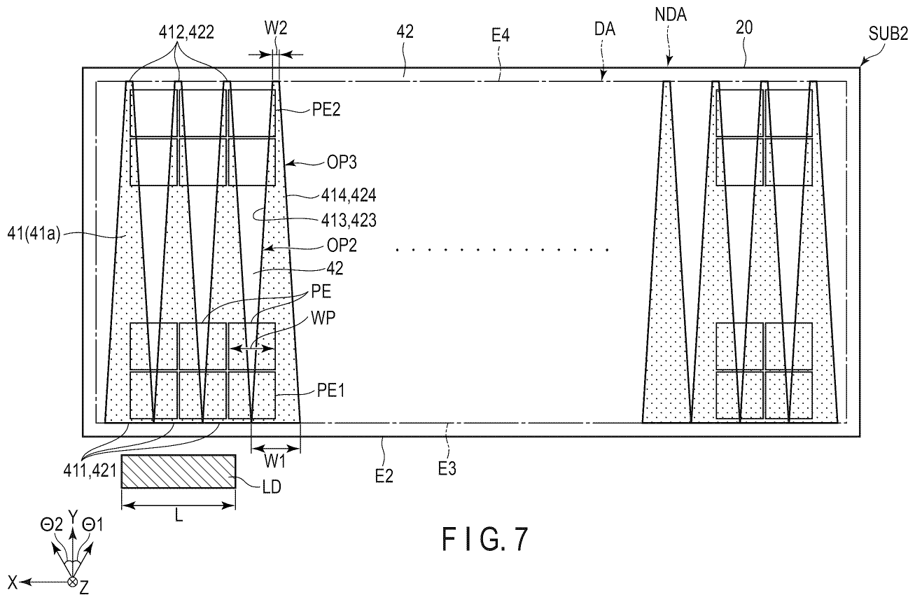

FIG. 7 is a plan view showing a configuration example of the second substrate shown in FIG. 6. Description of the same configuration as the above-described configuration example will be omitted with reference to the above description. In FIG. 7, the protective layer 50 is omitted. In addition, in FIG. 7, the band portion 41a is shown schematically with the width enlarged in the first direction X. Furthermore, in FIG. 7, the area overlapping with the display portion DA is represented by a dashed line.

The transparent layer 41 includes a plurality of band portions 41a arranged in the first direction X. The transparent layer 42 is formed between the adjacent band portions 41a, i.e., in the aperture OP2, and overlaps with the aperture OP2 in plan view. From another viewpoint, the transparent layer 42 includes a plurality of apertures OP3. In the example shown in FIG. 7, the plurality of apertures OP3 are arranged in the first direction X and extend in the second direction Y. The band portion 41a is formed in each of the plurality of apertures OP3.

The apertures OP3 have the same planar shape as the transparent layer 41. In the example shown in FIG. 7, the aperture OP3 has a first end portion 421 on the side facing the light emitting element LD, a second end portion 422 on the side opposite to the first end portion 421, a first edge 423, and a second edge 424. The aperture OP3 has a width gradually decreasing at a constant rate or any rate, from the first end portion 421 toward the second end portion 422. In the example shown in FIG. 7, the transparent layer 42 is also provided around a peripheral portion of the second substrate SUB2 so as to surround the plurality of band portions 41a.

The pixel electrode PE overlaps with two adjacent transparent layers 41 in plan view. The pixel electrode PE overlaps with the transparent layer 42 between the transparent layers 41, i.e., through the aperture OP2.

The display device DSP applies an electric field to the liquid crystal layer LC to change the alignment direction of the liquid crystal molecules, thereby scattering the light L1 made incident on the liquid crystal layer LC. If the thickness of the liquid crystal layer LC is uneven, the electric field strength applied to the liquid crystal layer LC becomes uneven, which may cause the display quality of the display panel PNL to be degraded.

The transparent layer 41 has a thickness of a constant or higher level to reflect the light L1. When the transparent layer 41 is provided in the display panel PNL, the thickness of the transparent layer 41 may cause the thickness of the liquid crystal layer LC to become uneven.

The transparent layer 42 is provided between two adjacent transparent layers 41, i.e., in the aperture OP2. Therefore, the difference in thickness between the area where the transparent layer 41 is provided (the area where the incidence of the light L1 on the display panel PNL is suppressed) and the area where the transparent layer 41 is not provided (the area where the light L1 is made incident on the display panel PNL) can be made small, and the alignment film AL2 provided on the protective layer 50 can be planarized. Accordingly, the distance between the alignment film AL1 and the alignment film AL2, i.e., the thickness of the liquid crystal layer LC can be made uniform.

In this configuration example, the same advantage as that of the configuration example shown in FIG. 2 can also be obtained. In addition, since non-uniform thickness of the liquid crystal layer LC can be suppressed, the degradation in display quality of the image displayed on the display panel PNL can be further suppressed.

As described above, according to the present embodiment, a display device capable of suppressing degradation in display quality can be provided.

In the present embodiment, for example, the transparent substrate 10 corresponds to the first transparent substrate, the transparent substrate 20 corresponds to the second transparent substrate, the transparent substrate 30 corresponds to the light guide, the transparent layer 41 corresponds to the first transparent layer, the transparent layer 42 corresponds to the second transparent layer, the pixel electrode PE1 corresponds to the first pixel electrode, and the pixel electrode PE2 corresponds to the second pixel electrode.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions. substrate.

What is claimed is:

1. A display device comprising:
a light guide;
a first transparent substrate;
a second transparent substrate provided between the light guide and the first transparent substrate;
a liquid crystal layer provided between the first transparent substrate and the second transparent substrate and containing streaky polymer and liquid crystal molecules;
a first transparent layer provided between the light guide and the first transparent substrate and including an aperture facing the liquid crystal layer; and
a protective layer provided between the light guide and the first transparent substrate, and overlapping with the aperture in plan view, wherein
the first transparent layer has a refractive index smaller than refractive indices of the second transparent substrate and the protective layer, and
the protective layer has light scattering properties higher than those of the second transparent substrate.

2. The display device of claim 1, wherein
the protective layer is provided between the second transparent substrate and the liquid crystal layer, and
the first transparent layer is provided between the second transparent substrate and the protective layer.

3. The display device of claim 2, further comprising:
a common electrode provided between the second transparent substrate and the first transparent layer, wherein
the protective layer is in contact with the common electrode at the aperture.

4. The display device of claim 1, further comprising:
a second transparent layer provided at the aperture, wherein
a refractive index of the second transparent layer is equivalent to a refractive index of the protective layer.

5. The display device of claim 4, wherein
the second transparent layer is formed of a material different from a material of the protective layer.

6. The display device of claim 4, wherein
the protective layer is provided between the second transparent substrate and the liquid crystal layer, and
the first transparent layer and second transparent layer are provided between the second transparent substrate and the protective layer.

7. The display device of claim 6, further comprising:
a common electrode provided between the second transparent substrate and the second transparent layer, wherein
the second transparent layer is in contact with the first transparent layer, the protective layer, and the common electrode.

8. The display device of claim 1, wherein
the protective layer contains a filler having light scattering properties.

9. The display device of claim 8, wherein
the filler is formed of an inorganic material.

10. The display device of claim 9, wherein
the filler is formed of hollow silica.

11. The display device of claim 1, further comprising:
a plurality of light emitting elements arranged in a first direction; and
a first pixel electrode and a second pixel electrode arranged in a second direction orthogonal to the first direction, wherein
the first pixel electrode is located between the second pixel electrode and the plurality of light emitting elements, and
an area where the first pixel electrode overlaps with the first transparent layer is larger than an area where the second pixel electrode overlaps with the first transparent layer, in plan view.

12. The display device of claim 11, wherein
the first transparent layer includes a plurality of band portions,
the plurality of band portions are arranged in the first direction and extend in the second direction, and
a width in the first direction, of each of the plurality of band portions, is smaller as a distance from the plurality of light emitting elements increases.
